(19) United States
(12) Patent Application Publication
(10) Pub. No.: US 2026/0052578 A1
(43) Pub. Date: Feb. 19, 2026

(54) SELECTIONS FOR PHYSICAL RANDOM ACCESS CHANNEL COMMUNICATIONS

(71) Applicant: QUALCOMM Incorporated, San Diego, CA (US)

(72) Inventors: Hung Dinh LY, San Diego, CA (US); Kexin XIAO, Shanghai (CN); Mahmoud TAHERZADEH BOROUJENI, San Diego, CA (US)

(21) Appl. No.: 19/101,838

(22) PCT Filed: Nov. 1, 2022
(86) PCT No.: PCT/CN2022/128895

§ 371 Date: Feb. 6, 2025

(51) Int. Cl. H04W 74/0833

(52) U.S. Cl. CPC H04W 74/0833

(57) ABSTRACT

Various aspects of the present disclosure generally relate to wireless communication. In some aspects, a user equipment (UE) may receive a configuration message for multiple physical random access channel (PRACH) communications. The UE may select, based at least in part on the configuration message, one or more random access channel (RACH) preamble indices for the multiple PRACH communications based at least in part on a rule for selecting a RACH preamble index. The UE may transmit the multiple PRACH communications based at least in part on the one or more RACH preamble indices. Numerous other aspects are described.

### FIELD OF THE DISCLOSURE

Aspects of the present disclosure generally relate to wireless communication and to techniques and apparatuses for selections for physical random access channel communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration message for multiple physical random access channel (PRACH) communications. The method may include selecting, based at least in part on the configuration message, one or more random access channel (RACH) preamble indices for the multiple PRACH communications based at least in part on a rule for selecting a RACH preamble index. The method may include transmitting the multiple PRACH communications based at least in part on the one or more RACH preamble indices.

Some aspects described herein relate to a method of wireless communication performed by a UE. The method may include receiving a configuration message for multiple PRACH communications. The method may include selecting, based at least in part on the configuration message, a transmit spatial filter for the multiple PRACH communications. The method may include transmitting the multiple PRACH communications using the transmit spatial filter, a same RACH format, and same time domain allocations.

Some aspects described herein relate to a method of wireless communication performed by a UE. The method may include receiving a configuration message for multiple PRACH communications. The method may include selecting, based at least in part on the configuration message, different transmit spatial filters for the multiple PRACH communications. The method may include transmitting the multiple PRACH communications using the different transmit spatial filters and a same RACH or different RACH formats.

Some aspects described herein relate to a method of wireless communication performed by a network entity. The method may include generating a configuration message for transmitting multiple PRACH communications, the configuration message being associated with a rule for selecting a RACH preamble index, selection of spatial filters, or selection of RACH formats. The method may include transmitting the configuration message.

Some aspects described herein relate to a UE for wireless communication. The UE may include a memory and one or more processors coupled to the memory. The one or more processors may be configured to receive a configuration message for multiple PRACH communications. The one or more processors may be configured to select, based at least in part on the configuration message, one or more RACH preamble indices for the multiple PRACH communications based at least in part on a rule for selecting a RACH preamble index. The one or more processors may be configured to transmit the multiple PRACH communications based at least in part on the one or more RACH preamble indices.

Some aspects described herein relate to a UE for wireless communication. The UE may include a memory and one or more processors coupled to the memory. The one or more processors may be configured to receive a configuration message for multiple PRACH communications. The one or more processors may be configured to select, based at least in part on the configuration message, a transmit spatial filter for the multiple PRACH communications. The one or more processors may be configured to transmit the multiple PRACH communications using the transmit spatial filter, a same RACH format, and same time domain allocations.

Some aspects described herein relate to a UE for wireless communication. The UE may include a memory and one or more processors coupled to the memory. The one or more processors may be configured to receive a configuration message for multiple PRACH communications. The one or more processors may be configured to select, based at least in part on the configuration message, different transmit spatial filters for the multiple PRACH communications. The one or more processors may be configured to transmit the multiple PRACH communications using the different transmit spatial filters and a same RACH or different RACH formats.

Some aspects described herein relate to a network entity for wireless communication. The network entity may include a memory and one or more processors coupled to the memory. The one or more processors may be configured to generate a configuration message for transmitting multiple PRACH communications, the configuration message being associated with a rule for selecting a RACH preamble index, selection of spatial filters, or selection of RACH formats. The one or more processors may be configured to transmit the configuration message.

Some aspects described herein relate to a non-transitory computer-readable medium that stores a set of instructions for wireless communication by a UE. The set of instructions, when executed by one or more processors of the UE, may cause the UE to receive a configuration message for multiple PRACH communications. The set of instructions, when executed by one or more processors of the UE, may cause the UE to select, based at least in part on the configuration message, one or more RACH preamble indices for the multiple PRACH communications based at least in part on a rule for selecting a RACH preamble index. The set of instructions, when executed by one or more processors of the UE, may cause the UE to transmit the multiple PRACH communications based at least in part on the one or more RACH preamble indices.

Some aspects described herein relate to a non-transitory computer-readable medium that stores a set of instructions for wireless communication by a UE. The set of instructions, when executed by one or more processors of the UE, may cause the UE to receive a configuration message for multiple PRACH communications. The set of instructions, when executed by one or more processors of the UE, may cause the UE to select, based at least in part on the configuration message, a transmit spatial filter for the multiple PRACH communications. The set of instructions, when executed by one or more processors of the UE, may cause the UE to transmit the multiple PRACH communications using the transmit spatial filter, a same RACH format, and same time domain allocations.

Some aspects described herein relate to a non-transitory computer-readable medium that stores a set of instructions for wireless communication by a UE. The set of instructions, when executed by one or more processors of the UE, may cause the UE to receive a configuration message for multiple PRACH communications. The set of instructions, when executed by one or more processors of the UE, may cause the UE to select, based at least in part on the configuration message, different transmit spatial filters for the multiple PRACH communications. The set of instructions, when executed by one or more processors of the UE, may cause the UE to transmit the multiple PRACH communications using the different transmit spatial filters and a same RACH or different RACH formats.

Some aspects described herein relate to a non-transitory computer-readable medium that stores a set of instructions for wireless communication by a network entity. The set of instructions, when executed by one or more processors of the network entity, may cause the network entity to generate a configuration message for transmitting multiple PRACH communications, the configuration message being associated with a rule for selecting a RACH preamble index, selection of spatial filters, or selection of RACH formats. The set of instructions, when executed by one or more processors of the network entity, may cause the network entity to transmit the configuration message.

Some aspects described herein relate to an apparatus for wireless communication. The apparatus may include means for receiving a configuration message for multiple PRACH communications. The apparatus may include means for selecting, based at least in part on the configuration message, one or more RACH preamble indices for the multiple PRACH communications based at least in part on a rule for selecting a RACH preamble index. The apparatus may include means for transmitting the multiple PRACH communications based at least in part on the one or more RACH preamble indices.

Some aspects described herein relate to an apparatus for wireless communication. The apparatus may include means for receiving a configuration message for multiple PRACH communications. The apparatus may include means for selecting, based at least in part on the configuration message, a transmit spatial filter for the multiple PRACH communications. The apparatus may include means for transmitting the multiple PRACH communications using the transmit spatial filter, a same RACH format, and same time domain allocations.

Some aspects described herein relate to an apparatus for wireless communication. The apparatus may include means for receiving a configuration message for multiple PRACH communications. The apparatus may include means for selecting, based at least in part on the configuration message, different transmit spatial filters for the multiple PRACH communications. The apparatus may include means for transmitting the multiple PRACH communications using the different transmit spatial filters and a same RACH or different RACH formats.

Some aspects described herein relate to an apparatus for wireless communication. The apparatus may include means for generating a configuration message for transmitting multiple PRACH communications, the configuration message being associated with a rule for selecting a RACH preamble index, selection of spatial filters, or selection of RACH formats. The apparatus may include means for transmitting the configuration message.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of using beams for communications between a network entity and a UE, in accordance with the present disclosure.

FIG. 5 is a diagram illustrating an example of a four-step random access procedure, in accordance with the present disclosure.

FIG. 6 is a diagram illustrating an example of using multiple beams for a four-step random access channel (RACH) procedure, in accordance with the present disclosure.

FIG. 7 is a diagram illustrating an example of a synchronization signal (SS) hierarchy, in accordance with the present disclosure.

FIG. 8 is a diagram illustrating an example of SS blocks (SSBs) associated with RACH occasions (ROs), in accordance with the present disclosure.

FIG. 9 is a diagram illustrating an example of SSBs associated with ROs, in accordance with the present disclosure.

FIG. 10 is a diagram illustrating an example associated with selecting RACH preamble indices, in accordance with the present disclosure.

FIG. 11 is a diagram illustrating an example associated with selecting a transmit spatial filter, in accordance with the present disclosure.

FIG. 12 is a diagram illustrating an example associated with selecting transmit spatial filters, in accordance with the present disclosure.

FIG. 13 is a diagram illustrating an example process performed, for example, by a UE, in accordance with the present disclosure.

FIG. 14 is a diagram illustrating an example process performed, for example, by a UE, in accordance with the present disclosure.

FIG. 15 is a diagram illustrating an example process performed, for example, by a UE, in accordance with the present disclosure.

FIG. 16 is a diagram illustrating an example process performed, for example, by a network entity, in accordance with the present disclosure.

FIG. 17 is a diagram of an example apparatus for wireless communication, in accordance with the present disclosure.

FIG. 18 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

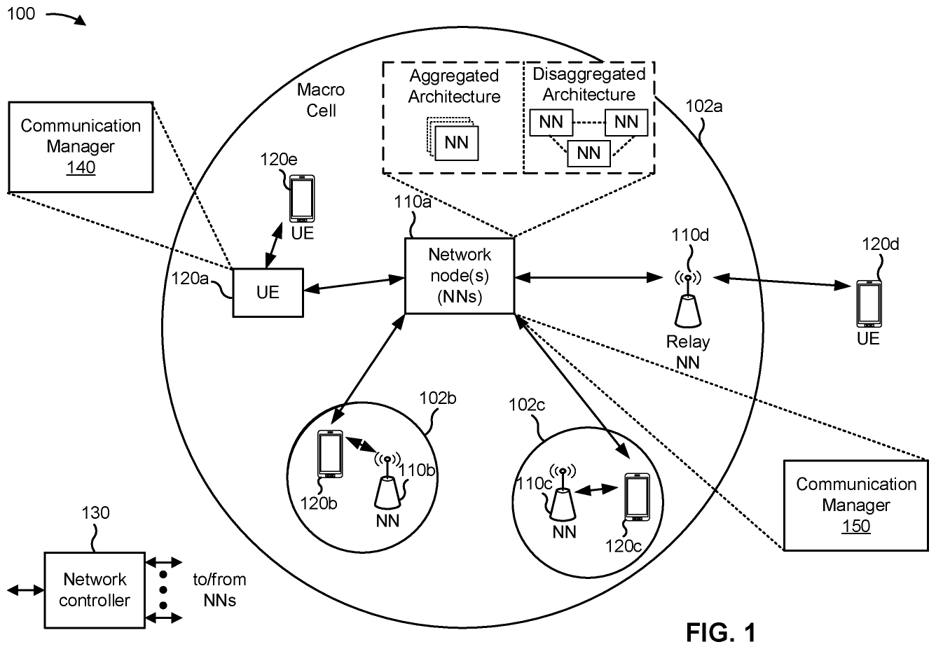

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station,” “network entity,” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station,” “network entity,” or “network node” may refer to one device configured to perform one or more functions, such as those described herein in connection with the network node 110. In some aspects, the terms “base station,” “network entity,” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station,” “network entity,” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station,” “network entity,” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive a configuration message for multiple physical random access channel (PRACH) communications. The communication manager 140 may select, based at least in part on the configuration message, one or more random access channel (RACH) preamble indices for the multiple PRACH communications based at least in part on a rule for selecting a RACH preamble index. The communication manager 140 may transmit the multiple PRACH communications based at least in part on the one or more RACH preamble indices.

In some aspects, the communication manager 140 may receive a configuration message for multiple PRACH communications. The communication manager 140 may select, based at least in part on the configuration message, a transmit spatial filter for the multiple PRACH communications. The communication manager 140 may transmit the multiple PRACH communications using the transmit spatial filter, a same RACH format, and same time domain allocations.

In some aspects, the communication manager 140 may receive a configuration message for multiple PRACH communications. The communication manager 140 may select, based at least in part on the configuration message, different transmit spatial filters for the multiple PRACH communications. The communication manager 140 may transmit the multiple PRACH communications using the different transmit spatial filters and a same RACH or different RACH formats. Additionally, or alternatively, the communication manager 140 may perform one or more other operations described herein.

In some aspects, a network entity (e.g., network node 110) may include a communication manager 150. As described in more detail elsewhere herein, the communication manager 150 may generate a configuration message for transmitting multiple PRACH communications, the configuration message being associated with a rule for selecting a RACH preamble index, selection of spatial filters, or selection of RACH formats. The communication manager 150 may transmit the configuration message. Additionally, or alternatively, the communication manager 150 may perform one or more other operations described herein.

As indicated above, FIG. 1 is provided as an example. Other examples may differ from what is described with regard to FIG. 1.

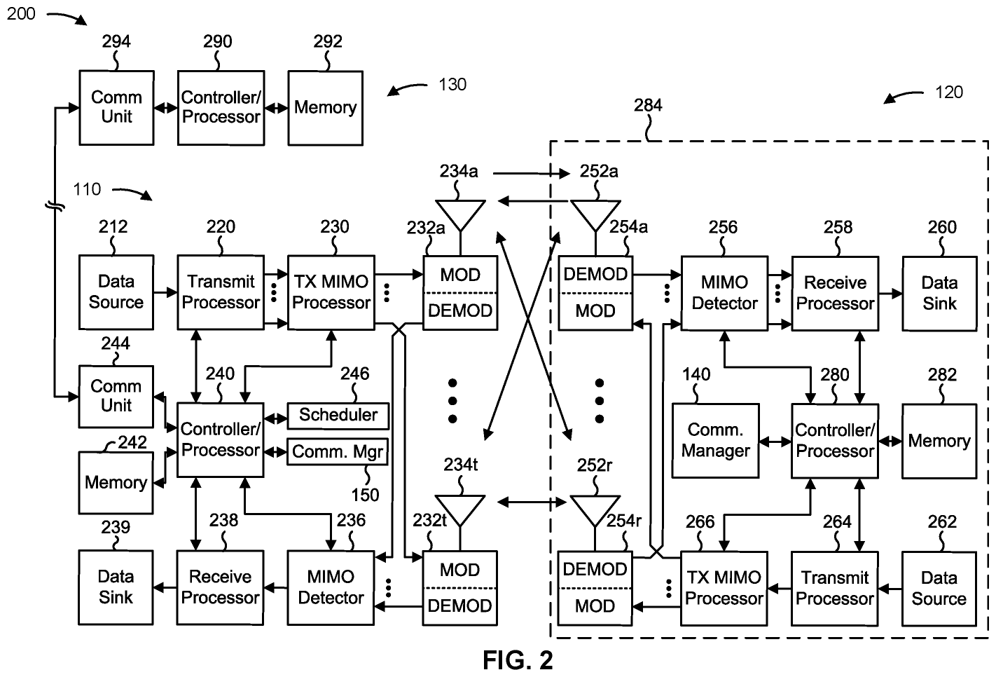

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream.

Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

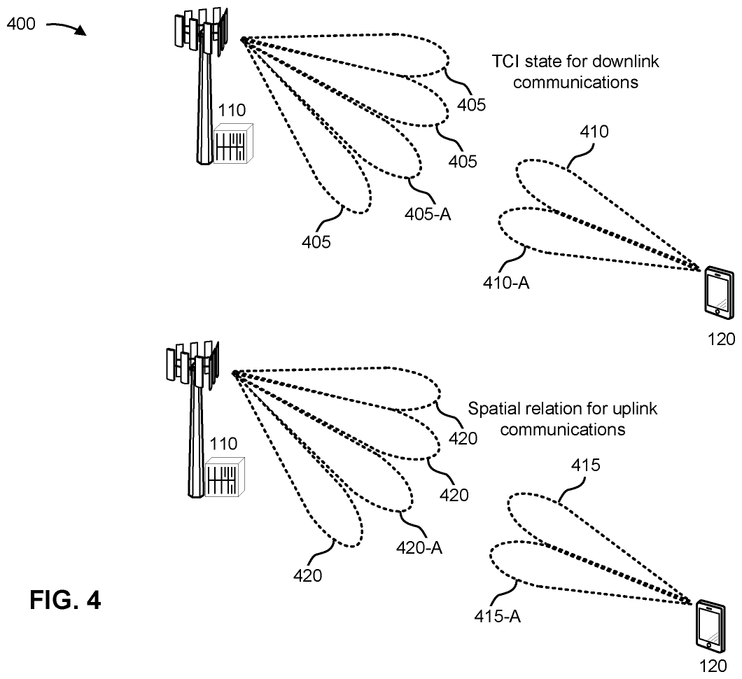

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-18).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-18).

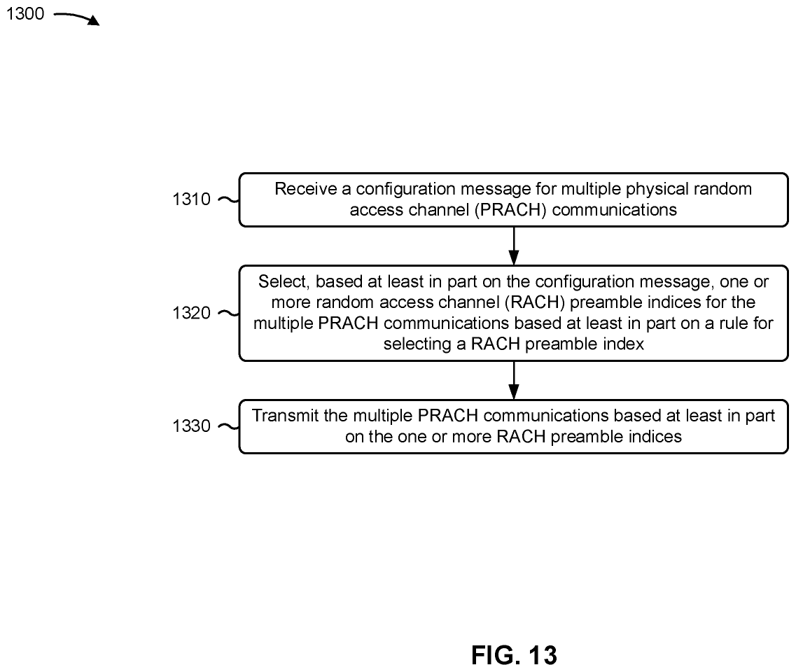

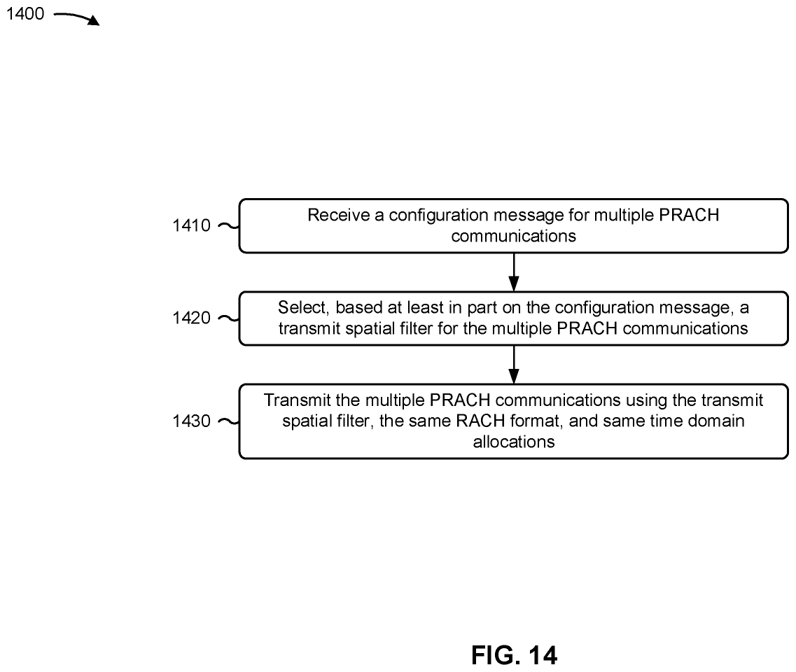

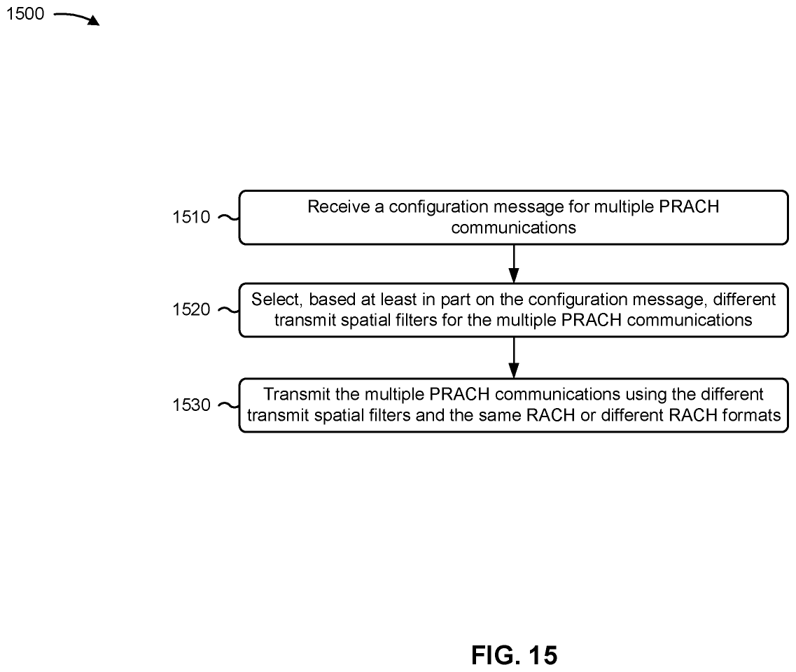

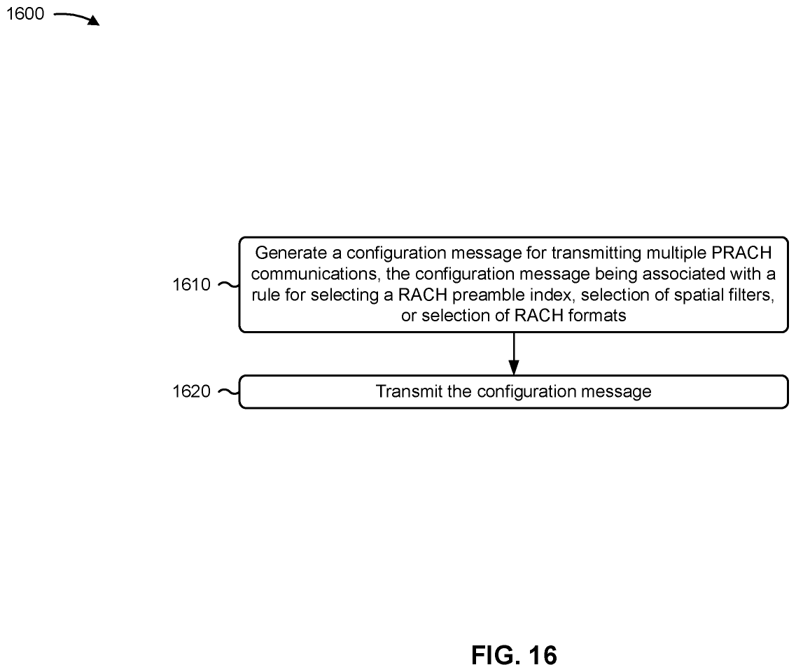

The controller/processor of a network entity (e.g., controller/processor 240 of the network node 110), the controller/processor 280 of the UE 120, and/or any other component(s) of FIG. 2 may perform one or more techniques associated with selecting RACH preamble indices, transmit spatial filters, and/or RACH formats for PRACH communications, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, process 1500 of FIG. 15, process 1600 of FIG. 16, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, process 1500 of FIG. 15, process 1600 of FIG. 16, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving a configuration message for multiple PRACH communications; means for selecting, based at least in part on the configuration message, one or more RACH preamble indices for the multiple PRACH communications based at least in part on a rule for selecting a RACH preamble index; and/or means for transmitting the multiple PRACH communications based at least in part on the one or more RACH preamble indices. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving a configuration message for multiple PRACH communications; means for selecting, based at least in part on the configuration message, a transmit spatial filter for the multiple PRACH communications; and/or means for transmitting the multiple PRACH communications using the transmit spatial filter, a same RACH format, and same time domain allocations.

In some aspects, the UE includes means for receiving a configuration message for multiple PRACH communications; means for selecting, based at least in part on the configuration message, different transmit spatial filters for the multiple PRACH communications; and/or means for transmitting the multiple PRACH communications using the different transmit spatial filters and a same RACH or different RACH formats.

In some aspects, a network entity (e.g., network node 110) includes means for generating a configuration message for transmitting multiple PRACH communications, the configuration message being associated with a rule for selecting a RACH preamble index, selection of spatial filters, or selection of RACH formats; and/or means for transmitting the configuration message. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

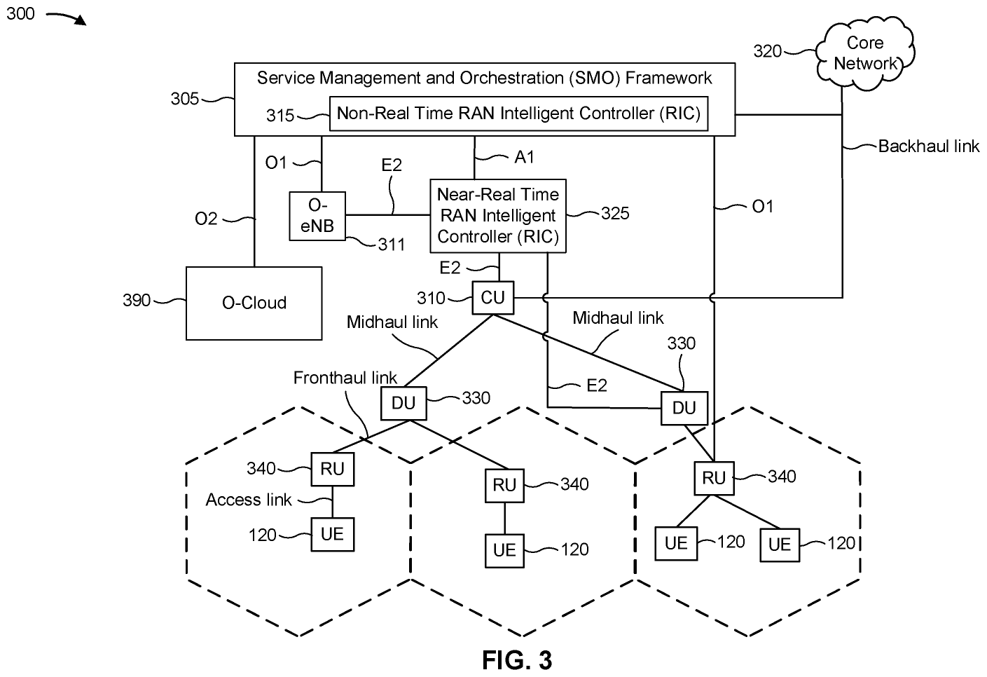

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or PRACH extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

FIG. 4 is a diagram illustrating an example 400 of using beams for communications between a network entity (e.g., network node 110) and a UE (e.g., UE 120), in accordance with the present disclosure. As shown in FIG. 4, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional network node (NN) transmit beam (e.g., a BS transmit beam), and the UE 120 may receive the transmission using a directional UE receive beam. Each NN transmit beam may have an associated beam ID, beam direction, or beam symbols, among other examples. The network node 110 may transmit downlink communications via one or more NN transmit beams 405.

The UE 120 may attempt to receive downlink transmissions via one or more UE receive beams 410, which may be configured using different beamforming parameters at receive circuitry of the UE 120. The UE 120 may identify a particular NN transmit beam 405, shown as NN transmit beam 405-A, and a particular UE receive beam 410, shown as UE receive beam 410-A, that provide relatively favorable performance (for example, that have a best channel quality of the different measured combinations of NN transmit beams 405 and UE receive beams 410). In some examples, the UE 120 may transmit an indication of which NN transmit beam 405 is identified by the UE 120 as a preferred NN transmit beam, which the network node 110 may select for transmissions to the UE 120. The UE 120 may thus attain and maintain a beam pair link (BPL) with the network node 110 for downlink communications (for example, a combination of the NN transmit beam 405-A and the UE receive beam 410-A), which may be further refined and maintained in accordance with one or more established beam refinement procedures.

A downlink beam, such as an NN transmit beam 405 or a UE receive beam 410, may be associated with a transmission configuration indication (TCI) state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. In some examples, each NN transmit beam 405 may be associated with a synchronization signal block (SSB), and the UE 120 may indicate a preferred NN transmit beam 405 by transmitting uplink transmissions in resources of the SSB that are associated with the preferred NN transmit beam 405. A particular SSB may have an associated TCI state (for example, for an antenna port or for beamforming). The network node 110 may, in some examples, indicate a downlink NN transmit beam 405 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based at least in part on the network node 110 indicating an NN transmit beam 405 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a physical downlink shared channel (PDSCH). The set of activated TCI states for downlink control channel communications may correspond to beams that the network node 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the network node 110 using a directional UE transmit beam, and the network node 110 may receive the transmission using a directional NN receive beam. Each UE transmit beam may have an associated beam ID, beam direction, or beam symbols, among other examples. The UE 120 may transmit uplink communications via one or more UE transmit beams 415.

The network node 110 may receive uplink transmissions via one or more NN receive beams 420 (e.g., BS receive beams). The network node 110 may identify a particular UE transmit beam 415, shown as UE transmit beam 415-A, and a particular NN receive beam 420, shown as NN receive beam 420-A, that provide relatively favorable performance (for example, that have a best channel quality of the different measured combinations of UE transmit beams 415 and NN receive beams 420). In some examples, the network node 110 may transmit an indication of which UE transmit beam 415 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 415-A and the NN receive beam 420-A), which may be further refined and maintained in accordance with one or more established beam refinement procedures. An uplink beam, such as a UE transmit beam 415 or an NN receive beam 420, may be associated with a spatial relation. A spatial relation may indicate a directionality or a characteristic of the uplink beam, similar to one or more QCL properties, as described above. A spatial relation or a beamforming configuration may also be referred to as a “spatial filter.” A spatial filter for transmission may be referred to as a “transmit spatial filter.”

As indicated above, FIG. 4 is provided as an example. Other examples may differ from what is described with respect to FIG. 4.

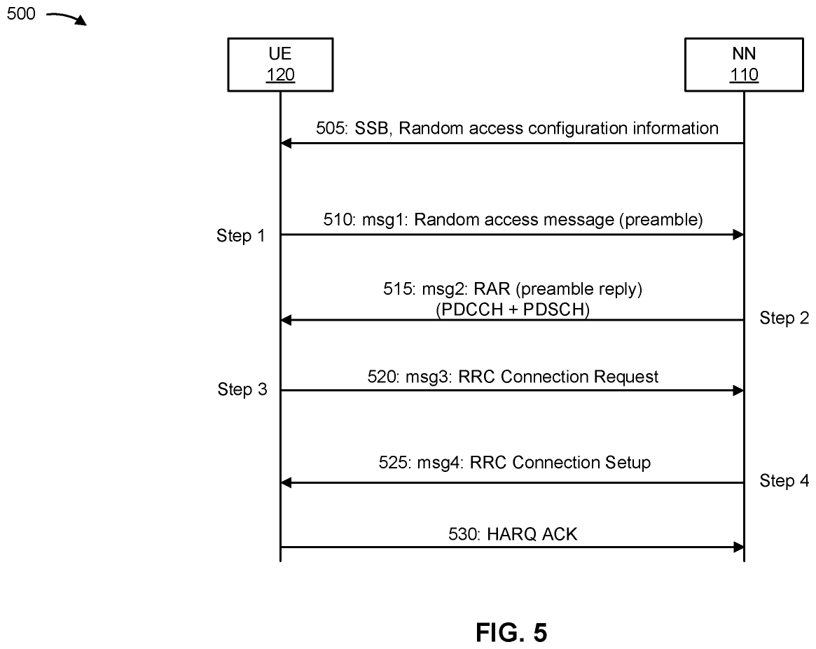

FIG. 5 is a diagram illustrating an example 500 of a four-step random access procedure, in accordance with the present disclosure. As shown in FIG. 5, a network entity (e.g., network node 110) and a UE (e.g., UE 120) may communicate with one another to perform the four-step random access procedure.

As shown by reference number 505, the network node 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 510, the UE 120 may transmit a RAM, which may include a preamble (sometimes referred to as a random access preamble, a RACH preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 515, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 520, the UE 120 may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request).

As shown by reference number 525, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 530, if the UE 120 successfully receives the RRC connection setup message, the UE 120 may transmit a hybrid automatic repeat request (HARQ) acknowledgement (ACK).

As indicated above, FIG. 5 is provided as an example. Other examples may differ from what is described with regard to FIG. 5.

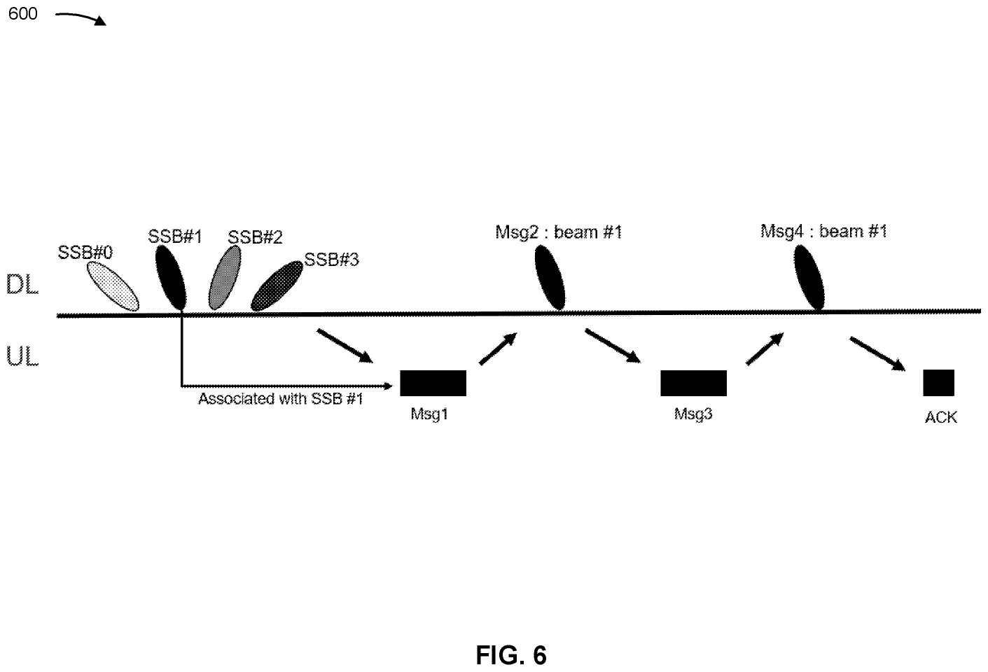

FIG. 6 is a diagram illustrating an example 600 of using multiple beams for a four-step RACH procedure, in accordance with the present disclosure.

PRACH communications may be transmitted with multiple beams (e.g., SSB #0, SSB #1, SSB #2, SSB #3) in a multi-beam system. SSBs may be mapped to RACH occasions (ROs) via a SIB. A UE may select the SSB based on the RSRP and select the PRACH resource associated with the selected SSB. The UE may transmit a PRACH communication using the spatial filter associated with the selected SSB. If a PRACH communication is received by a network entity, the network entity may use the same beam (e.g., beam #1) for the transmission of a Msg2 PDCCH/PDSCH and a Msg4 PDCCH/PDSCH. The UE may transmit a Msg3 PUSCH using the same spatial filter (e.g., for beam #1) that the UE uses to transmit the PRACH communication.

As indicated above, FIG. 6 is provided as an example. Other examples may differ from what is described with regard to FIG. 6.

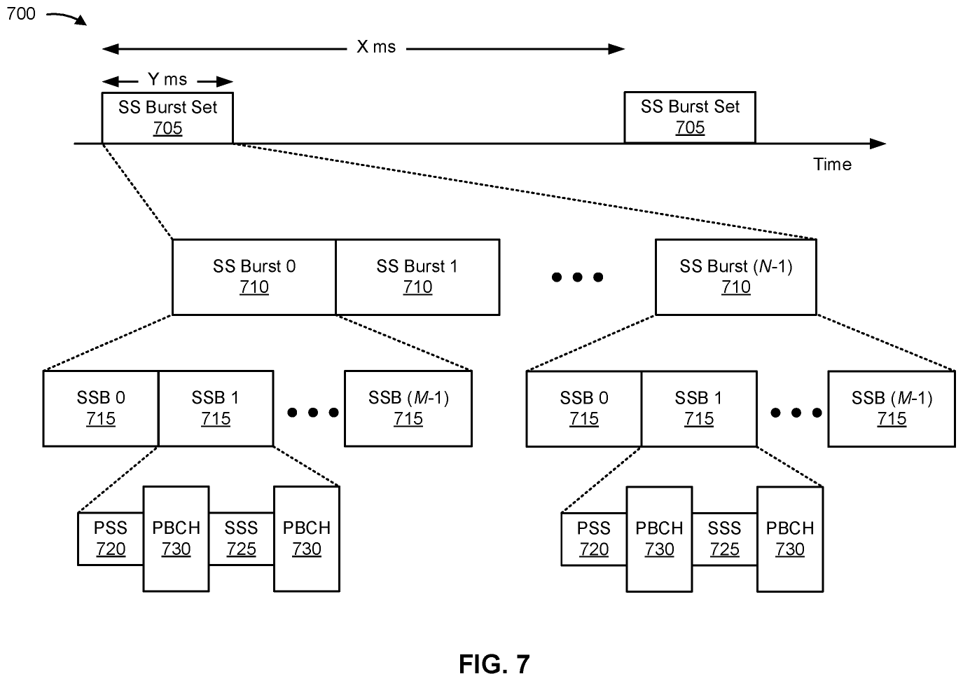

FIG. 7 is a diagram illustrating an example 700 of an SS hierarchy, in accordance with the present disclosure. As shown in FIG. 7, the SS hierarchy may include an SS burst set 705, which may include multiple SS bursts 710, shown as SS burst 0 through SS burst N−1, where N is a maximum number of repetitions of the SS burst 710 that may be transmitted by one or more network nodes. As further shown, each SS burst 710 may include one or more SSBs 715, shown as SSB 0 through SSB M−1, where M is a maximum number of SSBs 715 that can be carried by an SS burst 710. In some aspects, different SSBs 715 may be beam-formed differently (e.g., transmitted using different beams), and may be used for cell search, cell acquisition, beam management, and/or beam selection (e.g., as part of an initial network access procedure). An SS burst set 705 may be periodically transmitted by a wireless node (e.g., a network entity such as network node 110), such as every X milliseconds, as shown in FIG. 7. In some aspects, an SS burst set 705 may have a fixed or dynamic length, shown as Y milliseconds in FIG. 7. In some cases, an SS burst set 705 or an SS burst 710 may be referred to as a discovery reference signal (DRS) transmission window or an SSB measurement time configuration (SMTC) window.

In some aspects, an SSB 715 may include resources that carry a primary synchronization signal (PSS) 720, a secondary synchronization signal (SSS) 725, and/or a physical broadcast channel (PBCH) 730. In some aspects, multiple SSBs 715 are included in an SS burst 710 (e.g., with transmission on different beams), and the PSS 720, the SSS 725, and/or the PBCH 730 may be the same across each SSB 715 of the SS burst 710. In some aspects, a single SSB 715 may be included in an SS burst 710. In some aspects, the SSB 715 may be at least four symbols (e.g., OFDM symbols) in length, where each symbol carries one or more of the PSS 720 (e.g., occupying one symbol), the SSS 725 (e.g., occupying one symbol), and/or the PBCH 730 (e.g., occupying two symbols). In some aspects, an SSB 715 may be referred to as an SS/PBCH block.

In some aspects, the symbols of an SSB 715 are consecutive, as shown in FIG. 7. In some aspects, the symbols of an SSB 715 are non-consecutive. Similarly, in some aspects, one or more SSBs 715 of the SS burst 710 may be transmitted in consecutive radio resources (e.g., consecutive symbols) during one or more slots. Additionally, or alternatively, one or more SSBs 715 of the SS burst 710 may be transmitted in non-consecutive radio resources.

In some aspects, the SS bursts 710 may have a burst period, and the SSBs 715 of the SS burst 710 may be transmitted by a wireless node (e.g., a network node 110) according to the burst period. In this case, the SSBs 715 may be repeated during each SS burst 710. In some aspects, the SS burst set 705 may have a burst set periodicity, whereby the SS bursts 710 of the SS burst set 705 are transmitted by the wireless node according to the fixed burst set periodicity. In other words, the SS bursts 710 may be repeated during each SS burst set 705.

In some aspects, an SSB 715 may include an SSB index, which may correspond to a beam used to carry the SSB 715. A UE 120 may monitor for and/or measure SSBs 715 using different receive (Rx) beams during an initial network access procedure and/or a cell search procedure, among other examples. Based at least in part on the monitoring and/or measuring, the UE 120 may indicate one or more SSBs 715 with a best signal parameter (e.g., an RSRP parameter) to a network node 110 (e.g., directly or via one or more other network nodes). The network node 110 and the UE 120 may use the one or more indicated SSBs 715 to select one or more beams to be used for communication between the network node 110 and the UE 120 (e.g., for a RACH procedure). Additionally, or alternatively, the UE 120 may use the SSB 715 and/or the SSB index to determine a cell timing for a cell via which the SSB 715 is received (e.g., a serving cell).

As indicated above, FIG. 7 is provided as an example. Other examples may differ from what is described with regard to FIG. 7.

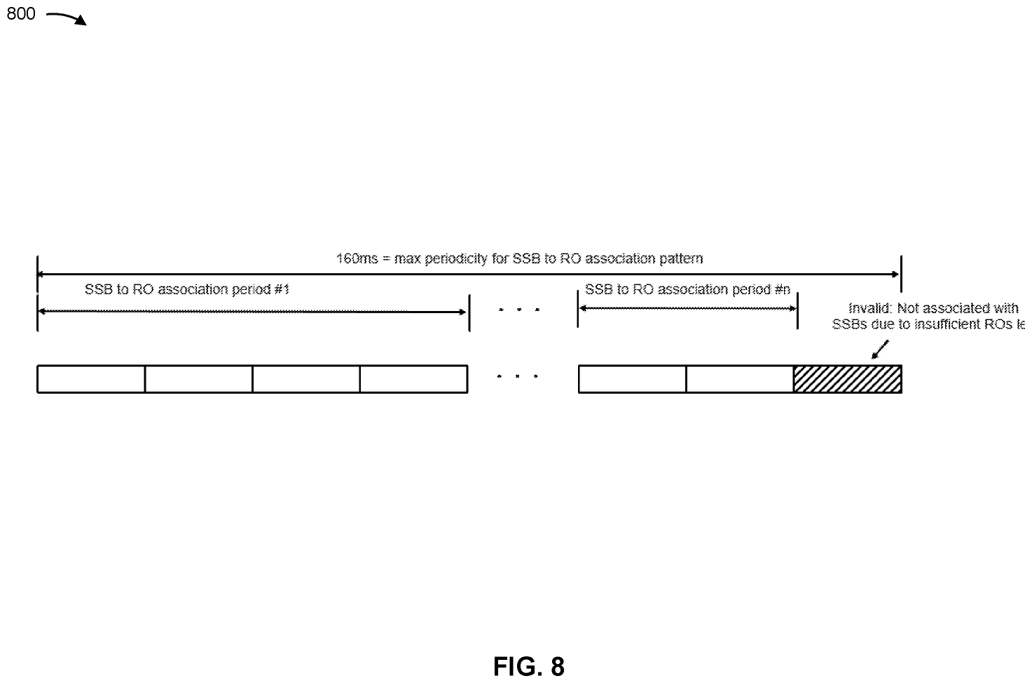

FIG. 8 is a diagram illustrating an example 800 of SSBs associated with RACH occasions, in accordance with the present disclosure.

SSBs may be associated with ROs. For a Type-1 random access procedure, the UE 120 may be provided a quantity of SSB indices associated with an RO and a quantity of contention-based preambles per SSB index per valid RO.

An association period, starting from frame 0, for mapping SSB indices to ROs may be the smallest value in a set determined by a PRACH configuration period. SSB indices may be mapped at least once to ROs with the association period. Example 800 shows SSB to RO association periods that occur according to a periodicity for an SSB to RO pattern. A frame that has insufficient ROs left may not be associated with SSBs.

As indicated above, FIG. 8 is provided as an example. Other examples may differ from what is described with regard to FIG. 8.

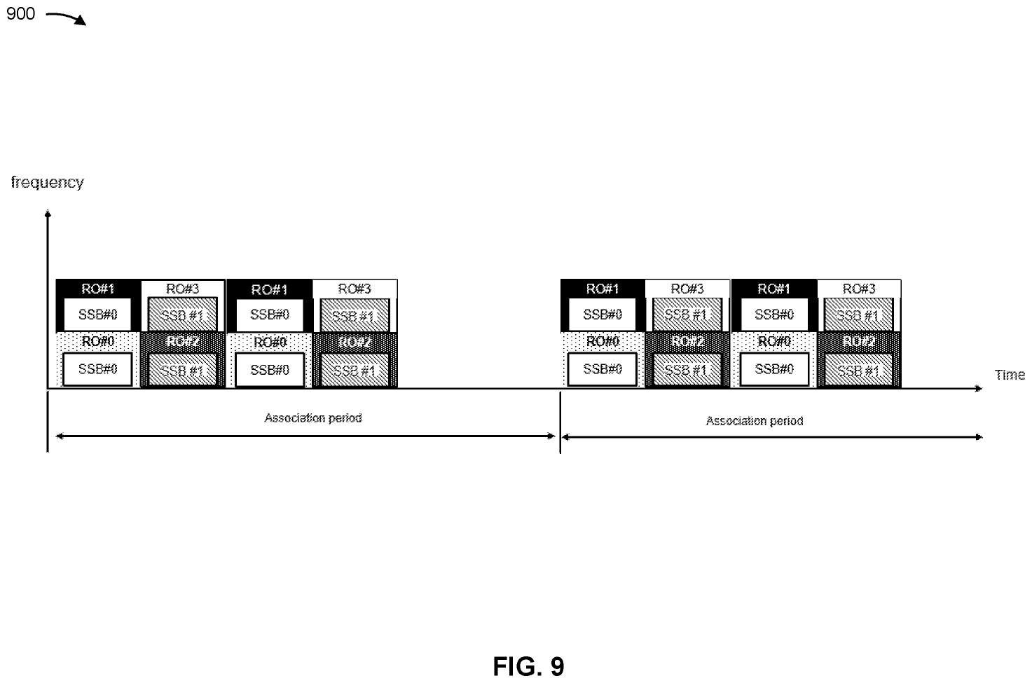

FIG. 9 is a diagram illustrating an example 900 of SSBs associated with ROs, in accordance with the present disclosure.

Example 900 shows that SSBs may be mapped to ROs, where there are two ROs for each SSB. For example, SSB #0 may be mapped to RO #0 and RO #1, and SSB #1 may be mapped to RO #2 and RO #3. Example 900 shows two cycles of the mapping of SSB indices to ROs within an association period. Sets of RACH preambles in ROs in a cell may be identical. There may be up to 64 RACH preambles in a set. The network may indicate the actual quantity of RACH preambles.

SSBs may be transmitted in a PRACH configuration period. However, the SSBs may not fit within one PRACH configuration period and thus there may be multiple PRACH configuration periods in an association period. PRACH communications may include PRACH repetitions, which may be repetitions of the same transport block.

As indicated above, FIG. 9 is provided as an example. Other examples may differ from what is described with regard to FIG. 9.

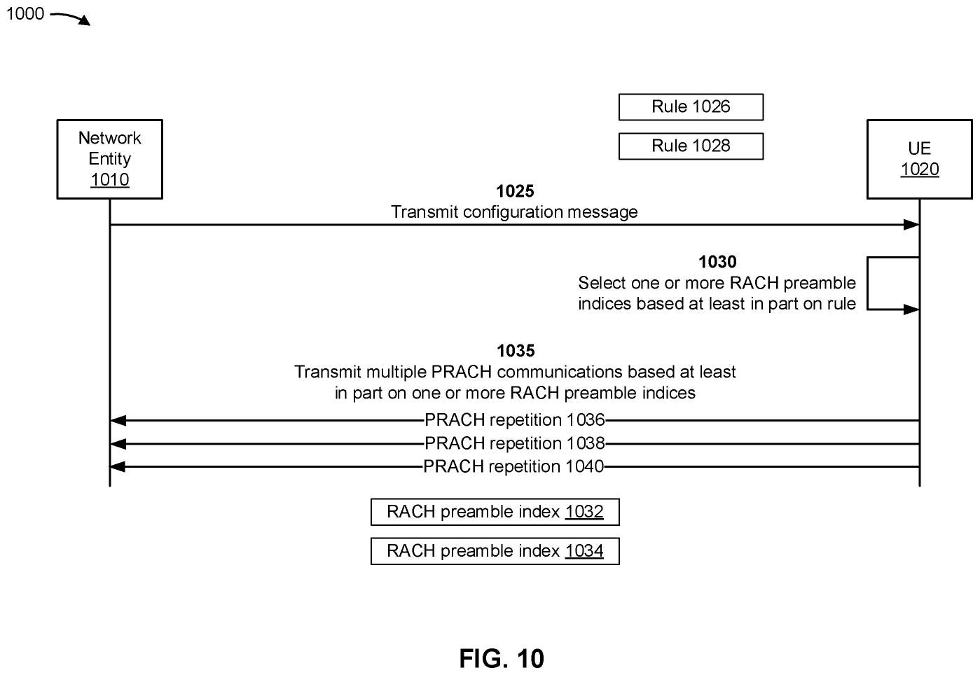

FIG. 10 is a diagram illustrating an example 1000 associated with selecting RACH preamble indices, in accordance with the present disclosure. As shown in FIG. 10, a network entity 1010 (e.g., network node 110) and a UE (e.g., UE 120) may communicate with one another via a wireless network (e.g., wireless network 100).

According to various aspects described herein, when a UE transmits multiple PRACH communications on the same beam or different beams, there may be options for selecting the RACH preamble for PRACH repetitions. In some aspects, a UE may receive a configuration message for multiple PRACH communications. The UE may select one or more RACH preambles (RACH preamble indices) for the multiple PRACH communications based at least in part on a rule for selecting a RACH preamble index. The configuration message may include or indicate the rule. The UE may select the same RACH preamble across PRACH repetitions. For example, the UE may randomly select one RACH preamble for the first PRACH repetition of an initial PRACH transmission and use the same RACH preamble for the other PRACH repetitions. In some aspects, the UE may select different preambles across the PRACH repetitions. This may include using a first RACH preamble for PRACH repetitions of an initial transmission and using a second RACH preamble for PRACH repetitions for re-transmission. In an example, the UE may randomly select the RACH preamble for each PRACH repetition.

In some aspects, the UE may follow a rule for selecting the RACH preamble for each PRACH repetition when transmitting multiple PRACH communications. This may help to randomize interference and reduce collision. The network may also know the set of RACH preambles that the UE is to use. The rule may specify selecting a RACH preamble index for a PRACH communication based at least in part on a total quantity of random access preambles (e.g., totalNumberOfRA-Preambles), an index of a PRACH communication, and time and frequency resources of a RACH occasion in which the PRACH communication is transmitted. For example, the rule may be based at least in part on parameters msg1-FDM, N_{Tx}^{SSB} (quantity of SSB indices mapped at least once to ROs within an association period), totalNumberOfRA-Preambles, the PRACH repetition index, and time/frequency of the RO in which the repetition is transmitted.

In an example, a rule may specify that a RACH preamble index of the kth PRACH repetition may be (i+(k−1)×(s_id+14×t_id+14×80×f_id))mod totalNumberOfRA-Preambles, where i is the preamble index of the first PRACH repetition, s_id is the index of the first OFDM symbol of the PRACH occasion (0≤s_id <14), and t_id is the index of the first slot of the PRACH occasion in a system frame (0≤t_id<80). The subcarrier spacing to determine t_id may be based at least in part on a specified value of μ, and f_id may be the index of the RO in the frequency domain (0≤f_id<8).

In some aspects, a rule may specify selecting a RACH preamble index for a PRACH communication based at least in part on a total quantity of random access preambles, an index of a first PRACH communication, and a quantity of synchronization signal blocks (N_{Tx}^{SSB}) . For example, the preamble index of the kth PRACH repetition may be (i+(k−1)×N_{Tx}^{SSB})mod totalNumberOfRA-Preambles, where i is the RACH preamble index of the first PRACH repetition.

In some aspects, a rule may specify selecting a RACH preamble index for a PRACH communication based at least in part on a total quantity of random access preambles, an index of a first PRACH communication, and a frequency domain parameter for a RACH msg1 (e.g., msg1-FDM). For example, the preamble index of the kth PRACH repetition may be (i+(k−1)msg1-FDM)mod totalNumberOfRA-Preambles, where i is the preamble index of the first PRACH repetition.

In some aspects, a rule may specify selecting a RACH preamble index for a PRACH communication based at least in part on a total quantity of random access preambles, an index of a first PRACH communication, and a delta parameter (Δ) configured by system information (SI). For example, the preamble index of the kth PRACH repetition may be (i+(k−1)×Δ)mod totalNumberOfRA-Preambles, where i is the preamble index of the first PRACH repetition and Δ may be configured in SI.

There may be multiple RACH formats for RACH preambles from which the UE may select. Such RACH formats may be specified in a table. In some aspects, a rule may specify selecting the same RACH format for different RACH preamble indices. In some aspects, a rule may specify selecting different RACH formats for the same RACH preamble index. In some aspects, a rule may specify selecting different RACH formats for different RACH preamble indices.

Example 1000 shows selection of a RACH preamble index. As shown by reference number 1025, the network entity 1010 may transmit a configuration message. The configuration message may be for the transmission of multiple PRACH communications, such as PRACH repetitions. The configuration message may include one or more rules (e.g., rule 1026, rule 1028) for selecting RACH preamble indices.

As shown by reference number 1030, the UE 1020 may select one or more RACH preamble indices (e.g., RACH preamble index 1032, RACH preamble index 1034) based at least in part on a rule (e.g., rule 1026) for selecting a RACH preamble index, such as any of the rules described above. The selection may be based at least in part on the configuration message because the configuration message may include or indicate rules or parameters for rules.

As shown by reference number 1035, the UE 1020 may transmit the PRACH communications, such as PRACH repetitions 1036, 1038, and 1040. The UE 1020 may use the same RACH preamble index (e.g., RACH preamble index 1032) for the PRACH repetitions 1036, 1038, and 1040. Alternatively, the UE 1020 may use different RACH preamble indices, such as RACH preamble index 1032 for PRACH repetition 1036, RACH preamble index 1034 for PRACH repetition 1038, and RACH preamble index 1032 for PRACH repetition 1040.

By using rules for the selection of RACH preamble indices, the UE 1020 may be more efficient in selecting appropriate RACH preamble indices when transmitting multiple PRACH communications. The increased efficiency may improve communications, which conserves power, processing resources, and signaling resources.

As indicated above, FIG. 10 is provided as an example. Other examples may differ from what is described with regard to FIG. 10.

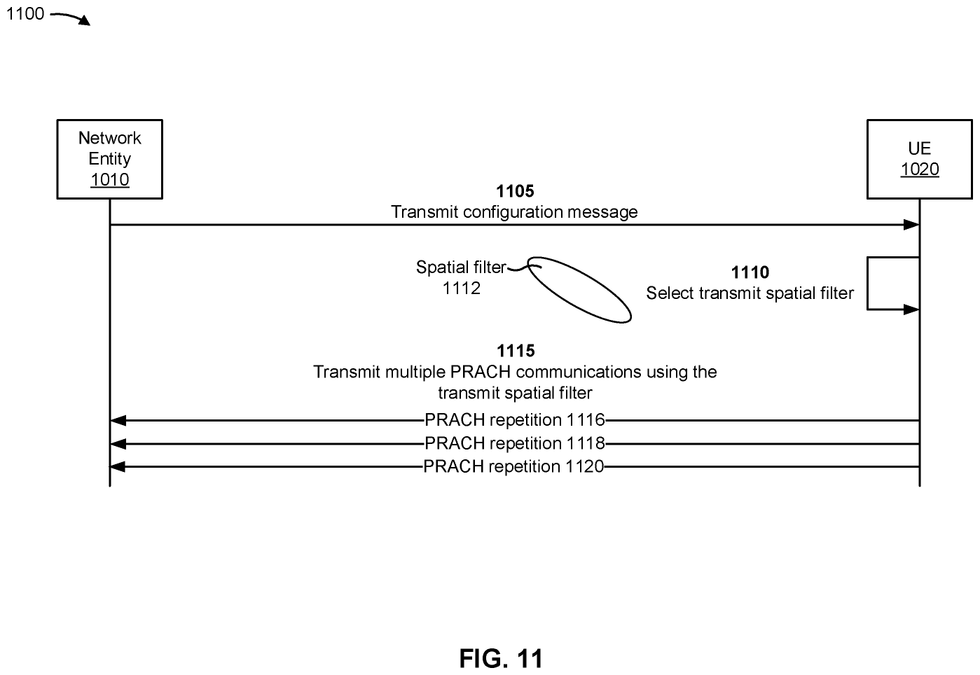

FIG. 11 is a diagram illustrating an example 1100 associated with selecting a transmit spatial filter, in accordance with the present disclosure.

In some aspects, when a UE transmits multiple PRACH communications on the same beam or different beams, there may be options for selecting spatial filters for PRACH repetitions. As shown by reference number 1105, the network entity 1010 may transmit a configuration message for multiple PRACH communications. As shown by reference number 1110, the UE 1020 may select a transmit spatial filter (e.g., spatial filter 1112) for the multiple PRACH communications. The configuration message may include or indicate the transmit spatial filter or a rule for selecting the transmit spatial filter.

As shown by reference number 1115, the UE 1020 may transmit multiple PRACH communications using the transmit spatial filter. For example, the UE 1020 may transmit PRACH repetitions 1116, 1118, and 1120 using spatial filter 1112. The UE 1020 may transmit the PRACH repetitions 1116, 1118, and 1120 using the same RACH format and/or the same time domain allocations for all of the PRACH repetitions 1116, 1118, and 1120.

By selecting the same transmit spatial filter for multiple PRACH repetitions, the UE 1020 may be more efficient in its beamforming, which conserves power, processing resources, and signaling resources.

As indicated above, FIG. 11 is provided as an example. Other examples may differ from what is described with regard to FIG. 11.

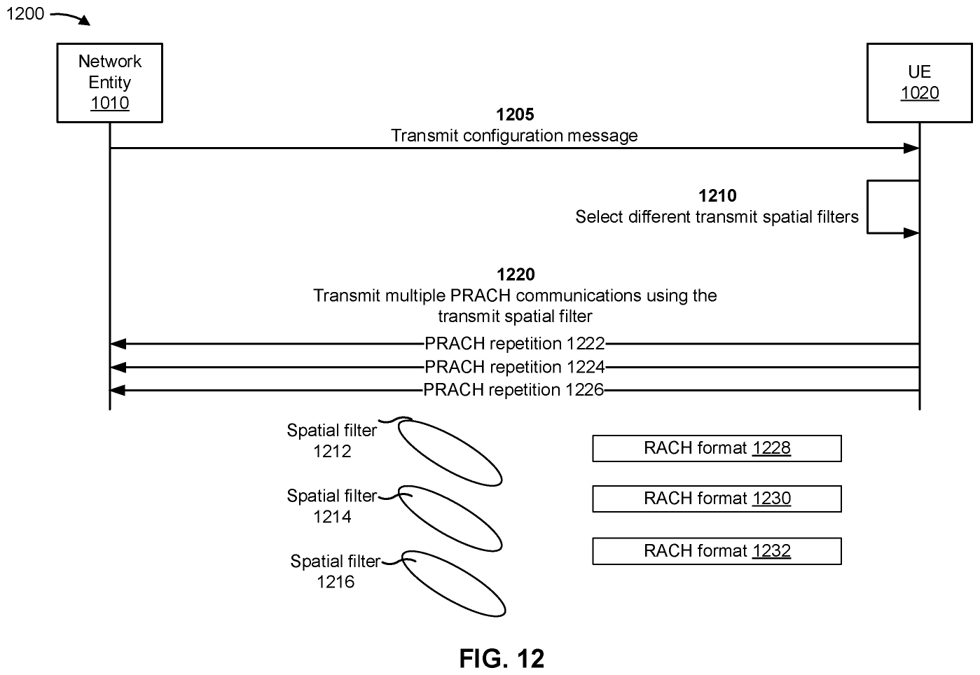

FIG. 12 is a diagram illustrating an example 1200 associated with selecting transmit spatial filters, in accordance with the present disclosure.

In some aspects, a UE may transmit multiple PRACH communications using different transmit spatial filters. As shown by reference number 1205, the network entity 1010 may transmit a configuration message for multiple PRACH communications. As shown by reference number 1210, the UE 1020 may select different transmit spatial filters (e.g., spatial filter 1212, spatial filter 1214, spatial filter 1216) for the multiple PRACH communications. The configuration message may include or indicate the transmit spatial filters or a rule for selecting the transmit spatial filters.

As shown by reference number 1220, the UE 1020 may transmit multiple PRACH communications using the different transmit spatial filters. For example, the UE 1020 may transmit PRACH repetition 1222 using spatial filter 1212, PRACH repetition 1224 using spatial filter 1214, and PRACH repetition 1226 using spatial filter 1216. In some aspects, the UE 1020 may use the same RACH format (e.g., RACH format 1228) for the PRACH repetitions, 1222, 1224, and 1226. In some aspects, the UE 1020 may use different RACH formats, such as RACH format 1228 for PRACH repetition 1222, RACH format 1230 for PRACH repetition 1224, and RACH format 1232 for PRACH repetition 1226.

In some aspects, the UE 1020 may use the same RACH format (e.g., RACH format 1228) for PRACH repetitions of an initial PRACH transmission and a different RACH format (e.g., RACH format 1232) for PRACH repetitions of a PRACH re-transmission.

In some aspects, if the UE 1020 is using different RACH formats for different PRACH repetitions, the UE 1020 may be configured with multiple RACH formats as part of a RACH configuration (e.g., if PRACH repetitions are transmitted using M transmit spatial filters, K≤M RACH formats can be configured. The UE 1020 may select the RACH format for a PRACH repetition based at least in part on a rule. For example, the UE 1020 may cycle through the RACH formats (e.g., spatial filter 1212 with RACH format 1228, spatial filter 1214 with RACH format 1230, and so forth). Alternatively, the network entity 1010 may indicate the association between an SSB index and a RACH format (e.g., RACH format 1228 for a first set of SSBs, RACH format 1230 for a second set of SSBs, where the SSB sets do not overlap).

In some aspects, the UE 1020 may use different transmit spatial filters and different RACH formats for the same RACH preamble index. In some aspects, the UE 102 may use different transmit spatial filters and different RACH formats. In some aspects, the UE 1020 may select a RACH format for a PRACH repetition based at least in part on a transmit spatial filter that is associated with the RACH format.

By using different RACH formats for different beams for multiple PRACH communications, the UE 1020 may have more effective beamforming in scenarios where beams have unbalanced coverage and/or radio channel conditions. This increased efficiency conserves power, processing resources, and signaling resources.

As indicated above, FIG. 12 is provided as an example. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120, UE 1020) performs operations associated with selecting RACH preamble indices for multiple PRACH communications.

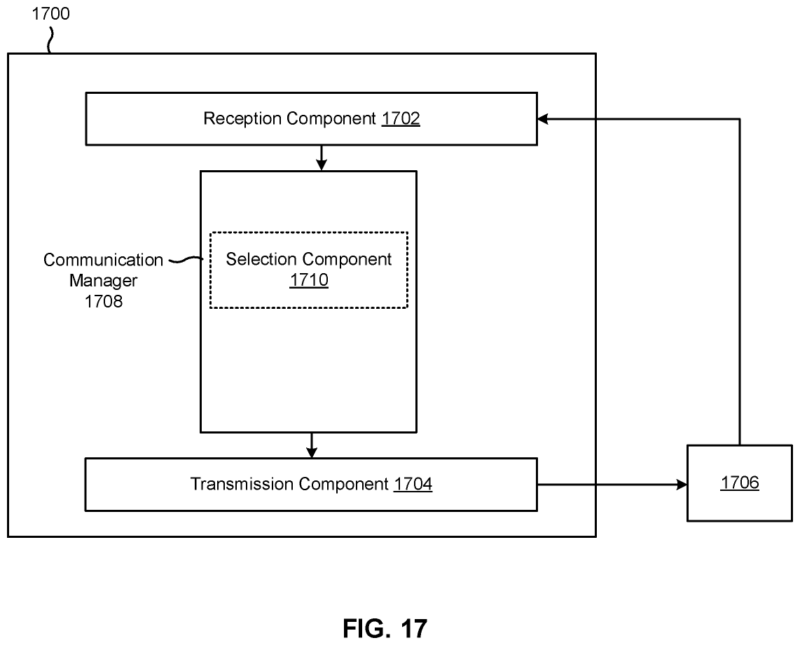

As shown in FIG. 13, in some aspects, process 1300 may include receiving a configuration message for multiple PRACH communications (block 1310). For example, the UE (e.g., using communication manager 1708 and/or reception component 1702 depicted in FIG. 17) may receive a configuration message for multiple PRACH communications, as described above.

As further shown in FIG. 13, in some aspects, process 1300 may include selecting, based at least in part on the configuration message, one or more RACH preamble indices for the multiple PRACH communications based at least in part on a rule for selecting a RACH preamble index (block 1320). For example, the UE (e.g., using communication manager 1708 and/or selection component 1710 depicted in FIG. 17) may select, based at least in part on the configuration message, one or more RACH preamble indices for the multiple PRACH communications based at least in part on a rule for selecting a RACH preamble index, as described above.

As further shown in FIG. 13, in some aspects, process 1300 may include transmitting the multiple PRACH communications based at least in part on the one or more RACH preamble indices (block 1330). For example, the UE (e.g., using communication manager 1708 and/or transmission component 1704 depicted in FIG. 17) may transmit the multiple PRACH communications based at least in part on the one or more RACH preamble indices, as described above.

Process 1300 may include additional aspects, such as any single aspect or any combination of aspects described below and/or in connection with one or more other processes described elsewhere herein.

In a first aspect, the multiple PRACH communications include PRACH repetitions.

In a second aspect, alone or in combination with the first aspect, the rule specifies selecting a RACH preamble index for a PRACH communication based at least in part on a total quantity of random access preambles, an index of a PRACH communication, and time and frequency resources of a RACH occasion in which the PRACH communication is transmitted.

In a third aspect, alone or in combination with one or more of the first and second aspects, the rule specifies selecting a RACH preamble index for a PRACH communication based at least in part on a total quantity of random access preambles, an index of a first symbol of a RACH occasion, an index of a first slot of the RACH occasion, and an index of the RACH occasion in a frequency domain.

In a fourth aspect, alone or in combination with one or more of the first through third aspects, the rule specifies selecting a RACH preamble index for a PRACH communication based at least in part on a total quantity of random access preambles, an index of a first PRACH communication, and a quantity of SSBs.

In a fifth aspect, alone or in combination with one or more of the first through fourth aspects, the rule specifies selecting a RACH preamble index for a PRACH communication based at least in part on a total quantity of random access preambles, an index of a first PRACH communication, and a frequency domain parameter for a RACH msg1.

In a sixth aspect, alone or in combination with one or more of the first through fifth aspects, the rule specifies selecting a RACH preamble index for a PRACH communication based at least in part on a total quantity of random access preambles, an index of a first PRACH communication, and a delta parameter configured by system information.

In a seventh aspect, alone or in combination with one or more of the first through sixth aspects, the rule specifies selecting a same RACH format for different RACH preamble indices of the one or more RACH preamble indices.

In an eighth aspect, alone or in combination with one or more of the first through seventh aspects, the rule specifies selecting different RACH formats for a same RACH preamble index of the one or more RACH preamble indices.

In a ninth aspect, alone or in combination with one or more of the first through eighth aspects, the rule specifies selecting different RACH formats for different RACH preamble indices of the one or more RACH preamble indices.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120, UE 1020) performs operations associated with selecting a transmit filter for multiple PRACH communications.

As shown in FIG. 14, in some aspects, process 1400 may include receiving a configuration message for multiple PRACH communications (block 1410). For example, the UE (e.g., using communication manager 1708 and/or reception component 1702 depicted in FIG. 17) may receive a configuration message for multiple PRACH communications, as described above.

As further shown in FIG. 14, in some aspects, process 1400 may include selecting, based at least in part on the configuration message, a transmit spatial filter for the multiple PRACH communications (block 1420). For example, the UE (e.g., using communication manager 1708 and/or selection component 1710 depicted in FIG. 17) may select, based at least in part on the configuration message, a transmit spatial filter for the multiple PRACH communications, as described above.

As further shown in FIG. 14, in some aspects, process 1400 may include transmitting the multiple PRACH communications using the transmit spatial filter, a same RACH format, and same time domain allocations (block 1430). For example, the UE (e.g., using communication manager 1708 and/or transmission component 1704 depicted in FIG. 17) may transmit the multiple PRACH communications using the transmit spatial filter, a same RACH format, and same time domain allocations, as described above.

Process 1400 may include additional aspects, such as any single aspect or any combination of aspects described below and/or in connection with one or more other processes described elsewhere herein.

In a first aspect, the multiple PRACH communications include PRACH repetitions.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a UE, in accordance with the present disclosure. Example process 1500 is an example where the UE (e.g., UE 120, UE 1020) performs operations associated with selecting transmit spatial filters for multiple PRACH communications.

As shown in FIG. 15, in some aspects, process 1500 may include receiving a configuration message for multiple PRACH communications (block 1510). For example, the UE (e.g., using communication manager 1708 and/or reception component 1702 depicted in FIG. 17) may receive a configuration message for multiple PRACH communications, as described above.

As further shown in FIG. 15, in some aspects, process 1500 may include selecting, based at least in part on the configuration message, different transmit spatial filters for the multiple PRACH communications (block 1520). For example, the UE (e.g., using communication manager 1708 and/or selection component 1710 depicted in FIG. 17) may select, based at least in part on the configuration message, different transmit spatial filters for the multiple PRACH communications, as described above.

As further shown in FIG. 15, in some aspects, process 1500 may include transmitting the multiple PRACH communications using the different transmit spatial filters and a same RACH or different RACH formats (block 1530). For example, the UE (e.g., using communication manager 1708 and/or transmission component 1704 depicted in FIG. 17) may transmit the multiple PRACH communications using the different transmit spatial filters and a same RACH or different RACH formats, as described above.

Process 1500 may include additional aspects, such as any single aspect or any combination of aspects described below and/or in connection with one or more other processes described elsewhere herein.

In a first aspect, the multiple PRACH communications include PRACH repetitions.

In a second aspect, alone or in combination with the first aspect, a RACH format for PRACH repetitions of an initial PRACH transmission is different than a RACH format for PRACH repetitions of a re-transmission.

In a third aspect, alone or in combination with one or more of the first and second aspects, transmitting the multiple PRACH communications includes transmitting PRACH repetitions using the same RACH format.

In a fourth aspect, alone or in combination with one or more of the first through third aspects, transmitting the multiple PRACH communications includes transmitting PRACH repetitions using the different RACH formats.

In a fifth aspect, alone or in combination with one or more of the first through fourth aspects, transmitting the multiple PRACH communications includes transmitting PRACH repetitions using the different transmit spatial filters and the different RACH formats for a same RACH preamble index.

In a sixth aspect, alone or in combination with one or more of the first through fifth aspects, transmitting the multiple PRACH communications includes transmitting PRACH repetitions using the different transmit spatial filters and the different RACH formats.

In a seventh aspect, alone or in combination with one or more of the first through sixth aspects, process 1500 includes selecting a RACH format for a PRACH repetition based at least in part on a transmit spatial filter that is associated with the RACH format.

In an eighth aspect, alone or in combination with one or more of the first through seventh aspects, process 1500 includes selecting a RACH format for a PRACH repetition based at least in part on an SSB index that is associated with the RACH format.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a network entity, in accordance with the present disclosure. Example process 1600 is an example where the network entity (e.g., network node 110, network entity 1010) performs operations associated with configuring a UE for multiple PRACH communications.

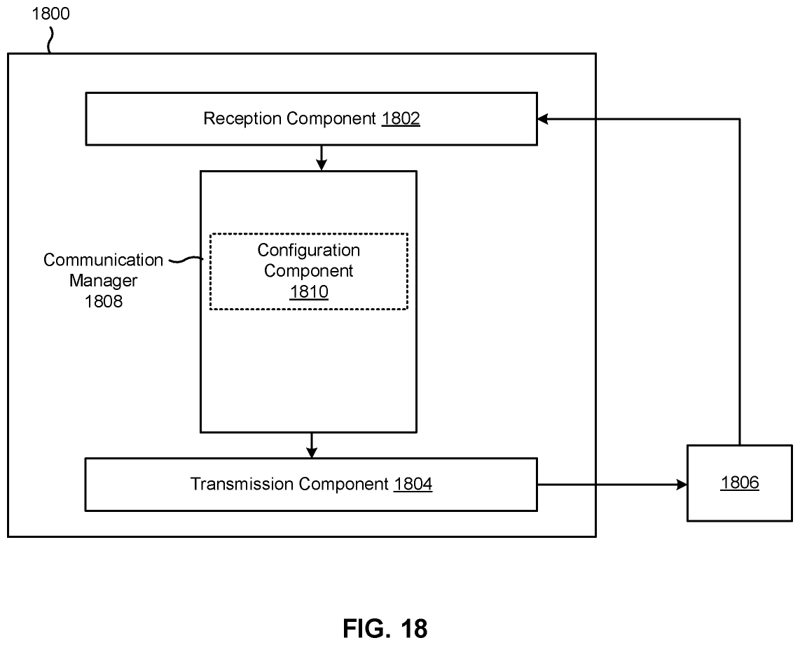

As shown in FIG. 16, in some aspects, process 1600 may include generating a configuration message for transmitting multiple PRACH communications, the configuration message being associated with a rule for selecting a RACH preamble index, selection of spatial filters, or selection of RACH formats (block 1610). For example, the network entity (e.g., using communication manager 1808 and/or configuration component 1810 depicted in FIG. 18) may generate a configuration message for transmitting multiple PRACH communications, the configuration message being associated with a rule for selecting a RACH preamble index, selection of spatial filters, or selection of RACH formats, as described above.

As further shown in FIG. 16, in some aspects, process 1600 may include transmitting the configuration message (block 1620). For example, the network entity (e.g., using communication manager 1808 and/or transmission component 1804 depicted in FIG. 18) may transmit the configuration message, as described above.

Process 1600 may include additional aspects, such as any single aspect or any combination of aspects described below and/or in connection with one or more other processes described elsewhere herein.

In a first aspect, the rule specifies selecting a RACH preamble index for a PRACH communication based at least in part on a total quantity of random access preambles, an index of a PRACH communication, and time and frequency resources of a RACH occasion in which the PRACH communication is transmitted.

In a second aspect, alone or in combination with the first aspect, the rule specifies selecting a RACH preamble index for a PRACH communication based at least in part on a total quantity of random access preambles, an index of a first symbol of a RACH occasion, an index of a first slot of the RACH occasion, and an index of the RACH occasion in a frequency domain.

In a third aspect, alone or in combination with one or more of the first and second aspects, the rule specifies selecting a RACH preamble index for a PRACH communication based at least in part on a total quantity of random access preambles, an index of a first PRACH communication, and a quantity of SSBs.

In a fourth aspect, alone or in combination with one or more of the first through third aspects, the rule specifies selecting a RACH preamble index for a PRACH communication based at least in part on a total quantity of random access preambles, an index of a first PRACH communication, and a frequency domain parameter for a RACH msg1.

In a fifth aspect, alone or in combination with one or more of the first through fourth aspects, the rule specifies selecting a RACH preamble index for a PRACH communication based at least in part on a total quantity of random access preambles, an index of a first PRACH communication, and a delta parameter configured by system information.

In a sixth aspect, alone or in combination with one or more of the first through fifth aspects, the multiple PRACH communications include PRACH repetitions, and the configuration message is associated with selecting a transmit spatial filter and a same RACH format for the PRACH repetitions.

In a seventh aspect, alone or in combination with one or more of the first through sixth aspects, the multiple PRACH communications include PRACH repetitions, and the configuration message is associated with selecting different transmit spatial filters and a same RACH format for the PRACH repetitions.

In an eighth aspect, alone or in combination with one or more of the first through seventh aspects, the multiple PRACH communications include PRACH repetitions, and the configuration message is associated with selecting different transmit spatial filters and different RACH formats for the PRACH repetitions.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram of an example apparatus 1700 for wireless communication, in accordance with the present disclosure. The apparatus 1700 may be a UE (e.g., UE 120, UE 1020), or a UE may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, network entity, or another wireless communication device) using the reception component 1702 and the transmission component 1704. As further shown, the apparatus 1700 may include the communication manager 1708. The communication manager 1708 may control and/or otherwise manage one or more operations of the reception component 1702 and/or the transmission component 1704. In some aspects, the communication manager 1708 may include one or more antennas, a modem, a controller/processor, a memory, or a combination thereof, of the UE described in connection with FIG. 2. The communication manager 1708 may be, or be similar to, the communication manager 140 depicted in FIGS. 1 and 2. For example, in some aspects, the communication manager 1708 may be configured to perform one or more of the functions described as being performed by the communication manager 140. In some aspects, the communication manager 1708 may include the reception component 1702 and/or the transmission component 1704. The communication manager 1708 may include a selection component 1710, among other examples.

In some aspects, the apparatus 1700 may be configured to perform one or more operations described herein in connection with FIGS. 1-12. Additionally, or alternatively, the apparatus 1700 may be configured to perform one or more processes described herein, such as process 1300 of FIG. 13, process 1400 of FIG. 14, process 1500 of FIG. 15, or a combination thereof. In some aspects, the apparatus 1700 and/or one or more components shown in FIG. 17 may include one or more components of the UE described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the UE described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the UE described in connection with FIG. 2. In some aspects, the transmission component 1704 may be co-located with the reception component 1702 in a transceiver.

In some aspects, the reception component 1702 may receive a configuration message for multiple PRACH communications. The selection component 1710 may select, based at least in part on the configuration message, one or more RACH preamble indices for the multiple PRACH communications based at least in part on a rule for selecting a RACH preamble index. The transmission component 1704 may transmit the multiple PRACH communications based at least in part on the one or more RACH preamble indices.

In some aspects, the reception component 1702 may receive a configuration message for multiple PRACH communications. The selection component 1710 may select, based at least in part on the configuration message, a transmit spatial filter for the multiple PRACH communications. The transmission component 1704 may transmit the multiple PRACH communications using the transmit spatial filter, a same RACH format, and same time domain allocations.

In some aspects, the reception component 1702 may receive a configuration message for multiple PRACH communications. The selection component 1710 may select, based at least in part on the configuration message, different transmit spatial filters for the multiple PRACH communications. The transmission component 1704 may transmit the multiple PRACH communications using the different transmit spatial filters and a same RACH format or different RACH formats.

The selection component 1710 may select a RACH format for a PRACH repetition based at least in part on a transmit spatial filter that is associated with the RACH format. The selection component 1710 may select a RACH format for a PRACH repetition based at least in part on a synchronization signal block index that is associated with the RACH format.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

FIG. 18 is a diagram of an example apparatus 1800 for wireless communication, in accordance with the present disclosure. The apparatus 1800 may be a network entity, or a network entity may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a base station, or another wireless communication device) using the reception component 1802 and the transmission component 1804. As further shown, the apparatus 1800 may include the communication manager 1808. The communication manager 1808 may control and/or otherwise manage one or more operations of the reception component 1802 and/or the transmission component 1804. In some aspects, the communication manager 1808 may include one or more antennas, a modem, a controller/processor, a memory, or a combination thereof, of the network entity described in connection with FIG. 2. The communication manager 1808 may be, or be similar to, the communication manager 150 depicted in FIGS. 1 and 2. For example, in some aspects, the communication manager 1808 may be configured to perform one or more of the functions described as being performed by the communication manager 150. In some aspects, the communication manager 1808 may include the reception component 1802 and/or the transmission component 1804. The communication manager 1808 may include a configuration component 1810, among other examples.

In some aspects, the apparatus 1800 may be configured to perform one or more operations described herein in connection with FIGS. 1-12. Additionally, or alternatively, the apparatus 1800 may be configured to perform one or more processes described herein, such as process 1600 of FIG. 16. In some aspects, the apparatus 1800 and/or one or more components shown in FIG. 18 may include one or more components of the network entity described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the network entity described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the network entity described in connection with FIG. 2. In some aspects, the transmission component 1804 may be co-located with the reception component 1802 in a transceiver.

The configuration component 1810 may generate a configuration message for transmitting multiple PRACH communications, the configuration message being associated with a rule for selecting a RACH preamble index, selection of spatial filters, or selection of RACH formats. The transmission component 1804 may transmit the configuration message.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

The following provides an overview of some Aspects of the present disclosure:

Aspect 1: A method of wireless communication performed by a user equipment (UE), comprising: receiving a configuration message for multiple physical random access channel (PRACH) communications; selecting, based at least in part on the configuration message, one or more random access channel (RACH) preamble indices for the multiple PRACH communications based at least in part on a rule for selecting a RACH preamble index; and transmitting the multiple PRACH communications based at least in part on the one or more RACH preamble indices.

Aspect 2: The method of Aspect 1, wherein the multiple PRACH communications include PRACH repetitions.

Aspect 3: The method of any of Aspects 1-2, wherein the rule specifies selecting a RACH preamble index for a PRACH communication based at least in part on a total quantity of random access preambles, an index of a PRACH communication, and time and frequency resources of a RACH occasion in which the PRACH communication is transmitted.

Aspect 4: The method of any of Aspects 1-3, wherein the rule specifies selecting a RACH preamble index for a PRACH communication based at least in part on a total quantity of random access preambles, an index of a first symbol of a RACH occasion, an index of a first slot of the RACH occasion, and an index of the RACH occasion in a frequency domain.

Aspect 5: The method of any of Aspects 1-4, wherein the rule specifies selecting a RACH preamble index for a PRACH communication based at least in part on a total quantity of random access preambles, an index of a first PRACH communication, and a quantity of synchronization signal blocks.

Aspect 6: The method of any of Aspects 1-5, wherein the rule specifies selecting a RACH preamble index for a PRACH communication based at least in part on a total quantity of random access preambles, an index of a first PRACH communication, and a frequency domain parameter for a RACH msg1.

Aspect 7: The method of any of Aspects 1-6, wherein the rule specifies selecting a RACH preamble index for a PRACH communication based at least in part on a total quantity of random access preambles, an index of a first PRACH communication, and a delta parameter configured by system information.

Aspect 8: The method of any of Aspects 1-7, wherein the rule specifies selecting a same RACH format for different RACH preamble indices of the one or more RACH preamble indices.

Aspect 9: The method of any of Aspects 1-8, wherein the rule specifies selecting different RACH formats for a same RACH preamble index of the one or more RACH preamble indices.

Aspect 10: The method of any of Aspects 1-8, wherein the rule specifies selecting different RACH formats for different RACH preamble indices of the one or more RACH preamble indices.

Aspect 11: A method of wireless communication performed by a user equipment (UE), comprising: receiving a configuration message for multiple physical random access channel (PRACH) communications; selecting, based at least in part on the configuration message, a transmit spatial filter for the multiple PRACH communications; and transmitting the multiple PRACH communications using the transmit spatial filter, a same random access channel (RACH) format, and same time domain allocations.

Aspect 12: The method of Aspect 11, wherein the multiple PRACH communications include PRACH repetitions.

Aspect 13: A method of wireless communication performed by a user equipment (UE), comprising: receiving a configuration message for multiple physical random access channel (PRACH) communications; selecting, based at least in part on the configuration message, different transmit spatial filters for the multiple PRACH communications; and transmitting the multiple PRACH communications using the different transmit spatial filters and a same random access channel (RACH) or different RACH formats.

Aspect 14: The method of Aspect 13, wherein the multiple PRACH communications include PRACH repetitions.

Aspect 15: The method of Aspect 14, wherein a RACH format for PRACH repetitions of an initial PRACH transmission is different than a RACH format for PRACH repetitions of a re-transmission.

Aspect 16: The method of any of Aspects 13-15, wherein transmitting the multiple PRACH communications includes transmitting PRACH repetitions using the same RACH format.

Aspect 17: The method of any of Aspects 13-15, wherein transmitting the multiple PRACH communications includes transmitting PRACH repetitions using the different RACH formats.

Aspect 18: The method of any of Aspects 13-17, wherein transmitting the multiple PRACH communications includes transmitting PRACH repetitions using the different transmit spatial filters and the different RACH formats for a same RACH preamble index.

Aspect 19: The method of any of Aspects 13-18, wherein transmitting the multiple PRACH communications includes transmitting PRACH repetitions using the different transmit spatial filters and the different RACH formats.

Aspect 20: The method of Aspect 19, further comprising selecting a RACH format for a PRACH repetition based at least in part on a transmit spatial filter that is associated with the RACH format.

Aspect 21: The method of Aspect 19, further comprising selecting a RACH format for a PRACH repetition based at least in part on a synchronization signal block index that is associated with the RACH format.

Aspect 22: A method of wireless communication performed by a network entity, comprising: generating a configuration message for transmitting multiple physical random access channel (PRACH) communications, the configuration message being associated with a rule for selecting a random access channel (RACH) preamble index, selection of spatial filters, or selection of RACH formats; and transmitting the configuration message.

Aspect 23: The method of Aspect 22, wherein the rule specifies selecting a RACH preamble index for a PRACH communication based at least in part on a total quantity of random access preambles, an index of a PRACH communication, and time and frequency resources of a RACH occasion in which the PRACH communication is transmitted.

Aspect 24: The method of any of Aspects 22-23, wherein the rule specifies selecting a RACH preamble index for a PRACH communication based at least in part on a total quantity of random access preambles, an index of a first symbol of a RACH occasion, an index of a first slot of the RACH occasion, and an index of the RACH occasion in a frequency domain.

Aspect 25: The method of any of Aspects 22-24, wherein the rule specifies selecting a RACH preamble index for a PRACH communication based at least in part on a total quantity of random access preambles, an index of a first PRACH communication, and a quantity of synchronization signal blocks.

Aspect 26: The method of any of Aspects 22-25, wherein the rule specifies selecting a RACH preamble index for a PRACH communication based at least in part on a total quantity of random access preambles, an index of a first PRACH communication, and a frequency domain parameter for a RACH msg1.

Aspect 27: The method of any of Aspects 22-26, wherein the rule specifies selecting a RACH preamble index for a PRACH communication based at least in part on a total quantity of random access preambles, an index of a first PRACH communication, and a delta parameter configured by system information.

Aspect 28: The method of any of Aspects 22-27, wherein the multiple PRACH communications include PRACH repetitions, and wherein the configuration message is associated with selecting a transmit spatial filter and a same RACH format for the PRACH repetitions.

Aspect 29: The method of any of Aspects 22-27, wherein the multiple PRACH communications include PRACH repetitions, and wherein the configuration message is associated with selecting different transmit spatial filters and a same RACH format for the PRACH repetitions.

Aspect 30: The method of any of Aspects 22-27, wherein the multiple PRACH communications include PRACH repetitions, and wherein the configuration message is associated with selecting different transmit spatial filters and different RACH formats for the PRACH repetitions.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) comprising:
a transceiver;
a memory comprising instructions; and
one or more processors configured to execute the instructions to cause the UE to:
receive, via the transceiver, a configuration message for multiple physical random access channel (PRACH) communications;
select, based at least in part on the configuration message, one or more random access channel (RACH) preamble indices for the multiple PRACH communications based at least in part on a rule for selecting a RACH preamble index; and
transmit, via the transceiver, the multiple PRACH communications based at least in part on the one or more RACH preamble indices.

2. The UE of claim 1, wherein the multiple PRACH communications include PRACH repetitions.

3. The UE of claim 1, wherein at least one of:
the rule specifies selecting a RACH preamble index for a PRACH communication based at least in part on a total quantity of random access preambles, an index of a PRACH communication, and time and frequency resources of a RACH occasion in which the PRACH communication is transmitted;
the rule specifies selecting a RACH preamble index for a PRACH communication based at least in part on a total quantity of random access preambles, an index of a first symbol of a RACH occasion, an index of a first slot of the RACH occasion, and an index of the RACH occasion in a frequency domain;
the rule specifies selecting a RACH preamble index for a PRACH communication based at least in part on a total quantity of random access preambles, an index of a first PRACH communication, and a quantity of synchronization signal blocks;
the rule specifies selecting a RACH preamble index for a PRACH communication based at least in part on a total quantity of random access preambles, an index of a first PRACH communication, and a frequency domain parameter for a RACH msg1;
the rule specifies selecting a RACH preamble index for a PRACH communication based at least in part on a total quantity of random access preambles, an index of a first PRACH communication, and a delta parameter configured by system information;
the rule specifies selecting a same RACH format for different RACH preamble indices of the one or more RACH preamble indices;
the rule specifies selecting different RACH formats for a same RACH preamble index of the one or more RACH preamble indices; or
the rule specifies selecting different RACH formats for different RACH preamble indices of the one or more RACH preamble indices.

4. (canceled)

5. (canceled)

6. (canceled)

7. (canceled)

8. (canceled)

9. (canceled)

10. (canceled)

11. (canceled)

12. (canceled)

13. A user equipment (UE), comprising:
a transceiver;
a memory comprising instructions; and
one or more processors configured to execute the instructions to cause the UE to:
receive, via the transceiver, a configuration message for multiple physical random access channel (PRACH) communications;
select, based at least in part on the configuration message, one or more different transmit spatial filters for the multiple PRACH communications; and
transmit, via the transceiver, the multiple PRACH communications using the one or more different transmit spatial filters and at least one of:
a same random access channel (RACH) format or different RACH formats; or
same time domain allocations.

14. The UE of claim 13, wherein the multiple PRACH communications include PRACH repetitions.

15. The UE of claim 14, wherein a RACH format for PRACH repetitions of an initial PRACH transmission is different than a RACH format for PRACH repetitions of a re-transmission.

16. The UE of claim 13, wherein the one or more processors, to transmit the multiple PRACH communications, are configured to transmit PRACH repetitions using the same RACH format.

17. The UE of claim 13, wherein the one or more processors, to transmit the multiple PRACH communications, are configured to transmit PRACH repetitions using the different RACH formats.

18. The UE of claim 13, wherein the one or more processors, to transmit the multiple PRACH communications, are configured to transmit PRACH repetitions using the one or more different transmit spatial filters and the different RACH formats for a same RACH preamble index.

19. The UE of claim 13, wherein the one or more processors, to transmit the multiple PRACH communications, are configured to transmit PRACH repetitions using the one or more different transmit spatial filters and the different RACH formats.

20. The UE of claim 19, wherein the one or more processors are further configured to select a RACH format for a PRACH repetition based at least in part on at least one of:
a transmit spatial filter that is associated with the RACH format; or
a synchronization signal block index that is associated with the RACH format.

21. (canceled)

22. A network entity, comprising:
a transceiver;
a memory comprising instructions; and
one or more processors configured to execute the instructions to cause the network entity to:
generate a configuration message for transmitting multiple physical random access channel (PRACH) communications, the configuration message being associated with a rule for selecting a random access channel (RACH) preamble index, selection of spatial filters, or selection of RACH formats; and
transmit, via the transceiver, the configuration message.

23. The network entity of claim 22, wherein the rule specifies selecting a RACH preamble index for a PRACH communication based at least in part on a total quantity of random access preambles, an index of a PRACH communication, and time and frequency resources of a RACH occasion in which the PRACH communication is transmitted.

24. The network entity of claim 22, wherein the rule specifies selecting a RACH preamble index for a PRACH communication based at least in part on a total quantity of random access preambles, an index of a first symbol of a RACH occasion, an index of a first slot of the RACH occasion, and an index of the RACH occasion in a frequency domain.

25. The network entity of claim 22, wherein the rule specifies selecting a RACH preamble index for a PRACH communication based at least in part on a total quantity of random access preambles, an index of a first PRACH communication, and a quantity of synchronization signal blocks.

26. The network entity of claim 22, wherein the rule specifies selecting a RACH preamble index for a PRACH communication based at least in part on a total quantity of random access preambles, an index of a first PRACH communication, and a frequency domain parameter for a RACH msg1.

27. The network entity of claim 22, wherein the rule specifies selecting a RACH preamble index for a PRACH communication based at least in part on a total quantity of random access preambles, an index of a first PRACH communication, and a delta parameter configured by system information.

28. The network entity of claim 22, wherein the multiple PRACH communications include PRACH repetitions, and wherein the configuration message is associated with selecting a transmit spatial filter and a same RACH format for the PRACH repetitions.

29. The network entity of claim 22, wherein the multiple PRACH communications include PRACH repetitions, and wherein the configuration message is associated with selecting different transmit spatial filters and a same RACH format for the PRACH repetitions.

30. The network entity of claim 22, wherein the multiple PRACH communications include PRACH repetitions, and wherein the configuration message is associated with selecting different transmit spatial filters and different RACH formats for the PRACH repetitions.
